(19) United States
(12) Patent Application Publication
(10) Pub. No.: US 2018/0217904 A1
(43) Pub. Date: Aug. 2, 2018

(54) Smart/Dumb Switch

(71) Applicant: Mark Forrest Vickers, Seattle, WA (US)

(72) Inventor: Mark Forrest Vickers, Seattle, WA (US)

(21) Appl. No.: 15/422,465

(22) Filed: Feb. 2, 2017

(51) Int. Cl. G06F 11/20

(52) U.S. Cl. CPC G06F 11/2028; G06F 21/56; G06F 11/2038

(57) ABSTRACT

A contrivance designed to ensure that an alternate method for critical functions of device are still available in the event of a malware infection or malfunction of the primary/“Smart” processor. A user selectable or automatic switch or similar contrivance that simultaneously directs the input and output devices to either solely the “smart” or “dumb” electronic circuitry/processor/brain. Thus providing a backup capability from the “dumb” electronic circuitry in the case of a malware infection or malfunction of the “smart” electronic circuitry/processor/“brain” of the device. By way of example a switch installed into a “smart” phone that can select a less capable, likely non field programmable, circuitry/processor/ “brain” that is capable of providing essential functions such as placing a phone call, or summoning emergency responders.

A contrivance designed to ensure that an alternate method for critical functions of device are still available in the event of a malware infection or malfunction of the primary/“Smart” processor. A user selectable or automatic switch or similar contrivance that simultaneously directs the input and output devices to either solely the “smart” or “dumb” electronic circuitry/processor/brain. Thus providing a backup capability from the “dumb” electronic circuitry in the case of a malware infection or malfunction of the “smart” electronic circuitry/“brain” of the device. By way of example a switch installed into a “smart” phone that can select a less capable, likely non field programmable, processor/“brain” that is capable of providing essential functions such as placing a phone call, or summoning emergency responders.

The term “Smart” in this document is intended to imply the commonly used vernacular describing a modern multifunction electronic device, “Smart Phone”, or other analogous relatively fluid and programmable electronics. Whereas the term “Dumb” in this document is intended to imply a more static device such as a non-programmable device implemented with circuits that are not easily programmable outside of the factory, such as those implemented with Read Only Memory (ROM), perhaps requiring specialized equipment and/or physical access to the interior of the phone/device and thus less likely to be infected with malware.

Although a smart phone is used in this example, this contrivance could be used for a plethora of devices such as refrigerators, thermostats, or virtually any software based device.

The embodiments of the invention in which an exclusive property or privilege is claimed are defined as follows:

1. A service restoration device consisting of: a switch, button, lever or similar contrivance located on a smart phone or other electronic device that simultaneously directs one, more or perhaps all of the input devices, output devices, communication circuitry, and/or power to either solely the “smart” or “dumb” electronic circuitry/processor/brain, in order to allow the “dumb” circuitry/processor/brain to operate autonomously, thus providing a backup capability provided by the “dumb” electronic circuitry that preserves the critical functions of the device and/or a select subset of desired functions.
A service restoration device consisting of: a switch, button, lever or similar contrivance to select between the “smart” electronic circuitry/processor/brain and the “dumb”/“backup” electronic circuity/processor/brain, thus providing a backup capability in the case of malware infection or malfunction of the “smart” electronic circuitry/processor/brain of the device.
A service restoration device consisting of: a switch, button, lever or similar contrivance located separate and external to the “smart” electronic circuitry and thereby immune to malware infecting the “smart” electronic circuity, that is capable of selecting a “dumb” set of circuitry that is capable of providing the essential functions of the device.
